(19) United States
(12) Patent Application Publication
(10) Pub. No.: US 2022/0220771 A1
(43) Pub. Date: Jul. 14, 2022

(54) LOCK TONGUE MODULE AND MODULAR LOCKSET

(71) Applicant: SINOX LOCK (KUNSHAN) CO., LTD., Kunshan (CN)

(72) Inventors: Wei WANG, Kunshan (CN); Tao SONG, Kunshan (CN); Xiaodi ZHANG, Kunshan (CN)

(21) Appl. No.: 17/543,834

(22) Filed: Dec. 7, 2021

(30) Foreign Application Priority Data
Jan. 13, 2021 (CN) 202110043750.7

(51) Int. Cl. E05B 15/10; E05B 15/04; E05B 37/00; E05B 63/14; E05B 65/52

(52) U.S. Cl. CPC E05B 15/10; E05B 15/04; E05B 2015/0448; E05B 63/146; E05B 65/5269; E05B 37/0034

(57) ABSTRACT

Provided are a lock tongue module and a modular lockset, relating to the technical field of modular locksets. The lock tongue module includes a base, a lock tongue, a lock block, a first elastic member and a second elastic member. The lock tongue is pivotally connected to the base and has a locking position in which the lock tongue is capable of locking a lock catch and an unlocking position in which the lock tongue is capable of releasing the lock catch. The lock block is movably connected to the base.

### CROSS-REFERENCE TO RELATED APPLICATION

This application claims priority to Chinese Patent Application No. 202110043750.7 filed Jan. 13, 2021, the disclosure of which is incorporated herein by reference in its entirety.

### TECHNICAL FIELD

The present disclosure relates to the technical field of locksets and, in particular, to a lock tongue module and a modular lockset.

### BACKGROUND

In order to ensure the safety of baggage, people often use a box with a lockset to load items when going out. The box includes, but is not limited to, a trunk, a suitcase, or a briefcase.

The lockset is generally used in combination with the zipper of the box. When the zipper is closed, the pull tab of the zipper can be inserted or embedded into the lock hole of the lockset. Then, a component such as a lock tongue which is movable and actuated in the locking hole of the above-mentioned lockset penetrates through a hole in the head of the pull tab to achieve the purpose of closing the zipper.

However, due to a large number of parts inside the lockset, the various parts need to be installed in the housing of the lockset one by one, so that the assembly process of the lockset is not convenient at present. In addition, to adapt to different case sizes and styles, the lockset needs to be redesigned after the shape of the lockset, the number of pull tabs and the actuating mode for unlocking is changed, which results in high research and development costs and a long production cycle.

### SUMMARY

The present disclosure provides a lock tongue module and a modular lockset. The lock tongue module is suitable for modularization assembly so as to reduce assembly difficulty. Moreover, the lock tongue module can be applied to various modular locksets in the form of an individual module so as to reduce lock redesign costs and shorten a lock production cycle.

The technical solutions described below are adopted to achieve this object.

A lock tongue module includes a base, a lock tongue, a lock block, a first elastic member and a second elastic member.

The lock tongue is pivotally connected to the base and has a locking position in which the lock tongue is capable of locking a lock catch and an unlocking position in which the lock tongue is capable of releasing the lock catch.

The lock block is movably connected to the base, and the lock block has a first operation position in which the lock block is capable of stopping the lock tongue in response to the lock tongue being in the locking position so as to block the lock tongue from rotating to the unlocking position and a second operation position in which the lock block is capable of avoiding the lock tongue in response to the lock tongue being in the unlocking position so as to allow the lock tongue to rotate to the locking position.

The first elastic member is configured to keep the lock tongue in the unlocking position.

The second elastic member is configured to keep the lock block in the first operation position.

In an embodiment, in response to the lock tongue being in the unlocking position, the lock tongue is capable of stopping the lock block so as to block the lock block from moving to the first operation position.

In an embodiment, the lock tongue includes a hook and an abutment block connected to the hook, and the lock tongue is capable of being driven by the lock catch to rotate from the unlocking position to the locking position when the lock catch is pushed against the abutment block, so that the lock catch is buckled with the hook.

In an embodiment, the abutment block is capable of abutting against the base in response to the lock tongue rotating to the locking position so as to block the lock tongue from continuing to rotate away from the unlocking position.

In an embodiment, a pair of lock tongues are coaxially arranged in a mirror image manner and pivotally connected to the base, and in response to the pair of lock tongues rotating to the unlocking position, the pair of lock tongues abut against each other to keep them together in the unlocking position.

The technical solutions described below are also adopted to achieve this object.

A modular lockset includes a housing, the lock tongue module assembled within the housing and an actuating module capable of unlocking the lock tongue module.

In an embodiment, the modular lockset also includes at least one lock body module assembled within the housing. The lock body module is configured to block the actuating module from unlocking the lock tongue module.

In an embodiment, the lock body module includes at least one of a key lock or a code lock.

In an embodiment, the modular lockset includes at least two lock tongue modules. The actuating modules are capable of simultaneously or individually unlocking all of the at least two lock tongue modules.

In an embodiment, the actuating module includes a first link, a second link and an unlocking button.

The first link is disposed within the housing, and the first link is slidable along the housing so as to actuate a lock block of one of the at least two lock tongue modules to move to a second operation position.

The second link is disposed within the housing, and the second link is slidable along the housing so as to actuate a lock block of another one of the at least two lock tongue modules to move to a second operation position.

The unlocking button is external to the housing.

The unlocking button is slidable along the housing and is capable of driving the first link and the second link to actuate the lock blocks of the two lock tongue modules when respectively sliding along two unlocking directions; or the unlocking button is slidable along the housing and is capable of driving the first link and the second link together to actuate the lock blocks of the two lock tongue modules when sliding along one unlocking direction.

### BRIEF DESCRIPTION OF DRAWINGS

FIG. 1 is a structure view of a modular lockset according to embodiment one of the present disclosure;

FIG. 2 is an exploded view of a modular lockset according to embodiment one of the present disclosure;

FIG. 3 is a structure view of a lock tongue module according to embodiment one of the present disclosure;

FIG. 4A is exploded view one of a lock tongue module according to embodiment one of the present disclosure;

FIG. 4B is exploded view two of a lock tongue module according to embodiment one of the present disclosure;

FIG. 5A is a perspective view of a lock tongue module in an unlocking position according to embodiment one of the present disclosure;

FIG. 5B is a bottom view of a lock tongue module in an unlocking position according to embodiment one of the present disclosure;

FIG. 5C is a structure view showing cooperation of a lock tongue module in an unlocking position with a first link according to embodiment one of the present disclosure;

FIG. 6A is a perspective view of a lock tongue module in a locking position according to embodiment one of the present disclosure;

FIG. 6B is a bottom view of a lock tongue module in a locking position according to embodiment one of the present disclosure;

FIG. 6C is a structure view showing cooperation of a lock tongue module in a locking position with a first link according to embodiment one of the present disclosure;

FIG. 7A is a structure view of a modular lockset when an unlocking button unlocks a first lock tongue module after a first lock body module is unlocked according to embodiment one of the present disclosure;

FIG. 7B is a structure view of a modular lockset when an unlocking button unlocks a second lock tongue module after a first lock body module is unlocked according to embodiment one of the present disclosure;

FIG. 8 is an exploded view of an unlocking button and a second lock body module according to embodiment one of the present disclosure;

FIG. 9 is a structure view showing a second modular lockset unlocking a first lock tongue module and a second lock tongue module according to embodiment one of the present disclosure;

FIG. 10A is a structure view of a modular lockset according to embodiment two of the present disclosure;

FIG. 10B is a structure view of another modular lockset according to embodiment two of the present disclosure; and

FIG. 11 is a structure view of a modular lockset according to embodiment three of the present disclosure.

### REFERENCE LIST

100. Housing
101. Lock hole
200. Lock tongue module
201. First lock tongue module
202. Second lock tongue module
300. Actuating module
301. First link
3011. Notch
302. Second link
303. Unlocking button
3031. Slot
400. First lock body module
401. Code wheel
402. Mandrel
500. Second lock body module
501. Lock cylinder
502. Unlocked block
600. Universal Serial Bus (USB) charging connector
1. Base
11. Body
12. Axle seat
13. Chute
14. Avoidance hole
15. Bump
16. Limiting block
2. Lock tongue
21. Hook
22. Abutment block
23. Stop lug
3. Lock block
31. Avoidance slot
32. Groove
33. Skirt
34. Gap
35. Boss
4. First elastic member
5. Second elastic member

### DETAILED DESCRIPTION

The present disclosure is further described below in detail in conjunction with drawings and embodiments. It is to be understood that the embodiments described herein are merely intended to explain the present disclosure and not to limit the present disclosure. Additionally, it is to be noted that for ease of description, merely part, not all, of the structures related to the present disclosure are illustrated in the drawings.

In the description of the present disclosure, unless otherwise expressly specified and limited, the term “connected to each other”, “connected”, or “fixed” is to be construed in a broad sense, for example, as fixedly connected, detachably connected, or integrated; mechanically connected or electrically connected; directly connected to each other or indirectly connected to each other via an intermediary; or internally connected or interactional between two components. For those of ordinary skill in the art, specific meanings of the preceding terms in the present disclosure may be construed based on specific situations.

In the present disclosure, unless otherwise expressly specified and limited, when a first feature is described as “above” or “below” a second feature, the first feature and the second feature may be in direct contact or be in contact via another feature between the two features. Moreover, when the first feature is described as “on”, “above” or “over” the second feature, the first feature is right on, above or over the second feature or the first feature is obliquely on, above or over the second feature, or the first feature is simply at a higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature.

In the description of this embodiment, the orientation or position relationships indicated by terms “above”, “below”, “right” and the like are based on the orientation or position relationships shown in the drawings, merely for ease of description and simplifying operation, and these relationships do not indicate or imply that the referred device or element has a specific orientation and is constructed and operated in a specific orientation, and thus these relationships are not to be construed as limiting the present disclosure. In addition, the terms “first” and “second” are used only to distinguish between descriptions and have no special meanings.

### Embodiment One

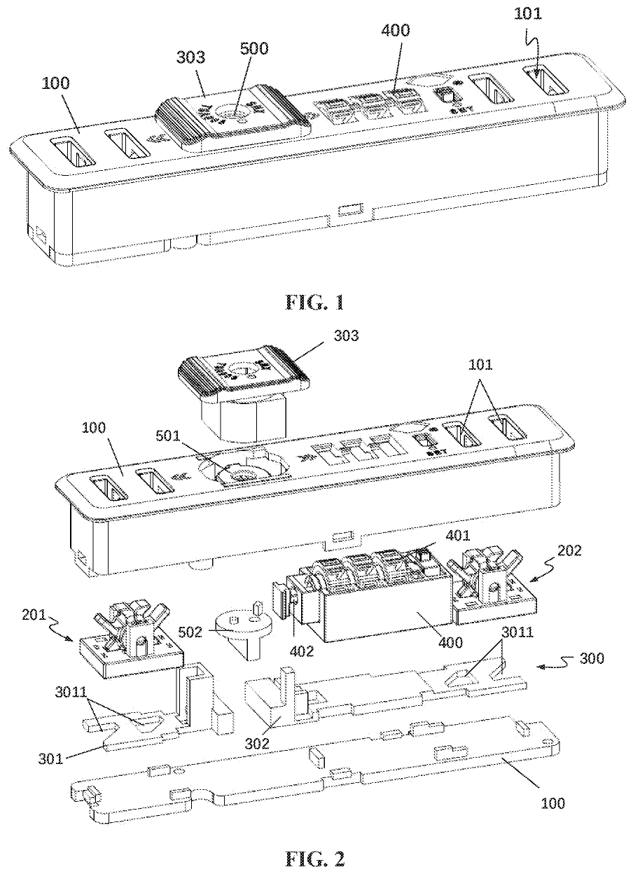

Referring to FIGS. 1 and 2, this embodiment provides a modular lockset. The modular lockset is used for trunks, suitcases, briefcases, or the like. Of course, in other optional embodiments, the modular lockset may also be used for other products requiring to be locked.

In general, a modular lockset for a case is to lock the pull tab of a case zipper through a lock tongue 2. That is, a user inserts the pull tab into a housing 100 through a lock hole 101 penetrating through the housing 100 of the modular lockset, so that the pull tab is buckled with the lock tongue 2. Moreover, the code lock and/or the key lock disposed within the housing 100 are/is used to keep the lock tongue 2 in the state of locking the pull tab.

In general, the code lock and the key lock adopt a modular component structure. However, the lock tongue 2 and the actuating parts, the resilient reset parts and the like for actuating the lock tongue 2 need to be connected to and cooperate with other members in the modular lockset such as the code lock, the key lock and the housing 100 of the modular lockset, resulting in that the existing modular lockset is difficult to assemble. Therefore, in order to simplify the assembly difficulty of the modular lockset, a better improvement direction is to modularize the lock tongue 2, the actuating parts, the resilient reset parts and the like so as to form a pre-installed assembly and reduce the connection and cooperation relationship between each part and other members in the modular lockset such as the code lock, the key lock and the housing 100.

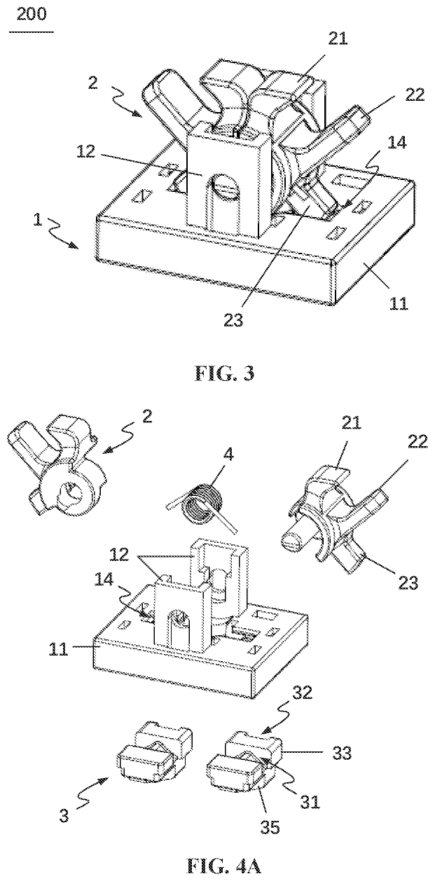

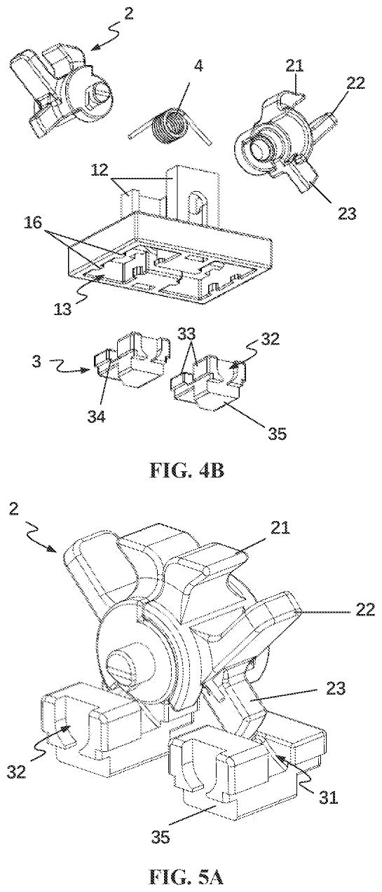

In view of the above, referring to FIGS. 3, 4A and 4B, this embodiment provides a lock tongue module 200. The lock tongue module 200 includes a base 1 and includes a lock tongue 2, a lock block 3, a first elastic member 4 and a second elastic member 5 which are installed together on the base 1. Specifically, the lock tongue 2 is pivotally connected to the base 1 so as to be rotatable around a shaft. Moreover, the lock tongue 2 has a locking position in which the lock tongue 2 is capable of locking a lock catch (i.e., the pull tab of the zipper or the like that needs to be locked by the modular lockset and the like) and an unlocking position in which the lock tongue 2 is capable of releasing the lock catch. The lock block 3 is movably connected to the base 1. Moreover, the lock block 3 has a first operation position in which the lock block 3 is capable of stopping the lock tongue 2 in response to the lock tongue 2 being in the locking position so as to block the lock tongue 2 from rotating to the unlocking position; and the lock block 3 has a second operation position in which the lock block 3 is capable of avoiding the lock tongue 2 in response to the lock tongue 2 being in the unlocking position so as to allow the lock tongue 2 to rotate to the locking position. The first elastic member 4 is configured to keep the lock tongue 2 in the unlocking position. The second elastic member 5 is configured to keep the lock block 3 in the first operation position.

In this embodiment, the first elastic member 4 may be a coil spring, and the second elastic member 5 may be a compression spring. The first elastic member 4 always provides a resetting elastic force for resetting the lock tongue 2 to the unlocking position. The second elastic member 5 always provides a resetting elastic force for resetting the lock block 3 to the first operation position.

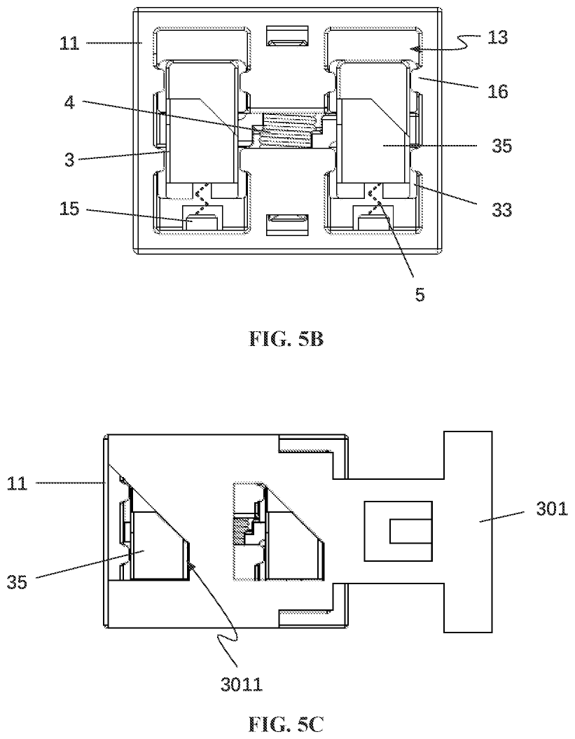

To facilitate the understanding of the operation principle of the lock tongue module 200, refer to FIGS. 5A and 5B first. When the lock tongue 2 is in the locking position, under the resetting elastic force of the second elastic member 5, the lock block 3, is pressed by the second elastic member 5 to abut against the base 1 and be kept in the first operation position. In this case, the lock block 3 stops the lock tongue 2 in the path in which the lock tongue 2 is reset to the unlocking position so as to block the lock tongue 2 from rotating to the unlocking position. Therefore, the lock tongue 2 is kept in the locking position in which the lock tongue 2 locks the lock catch.

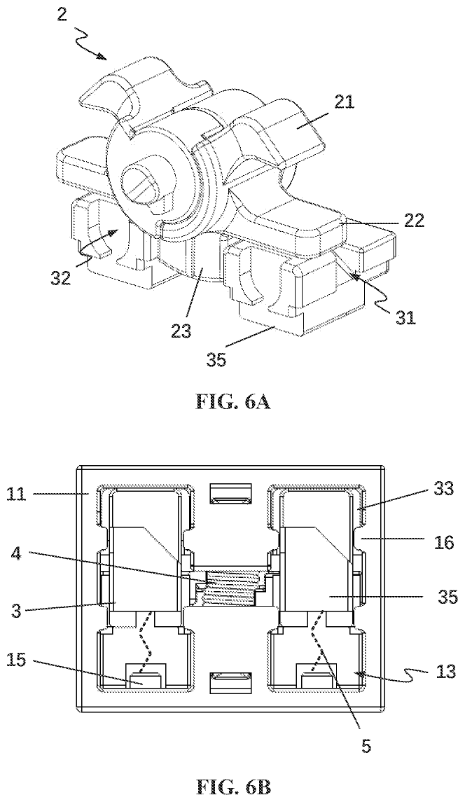

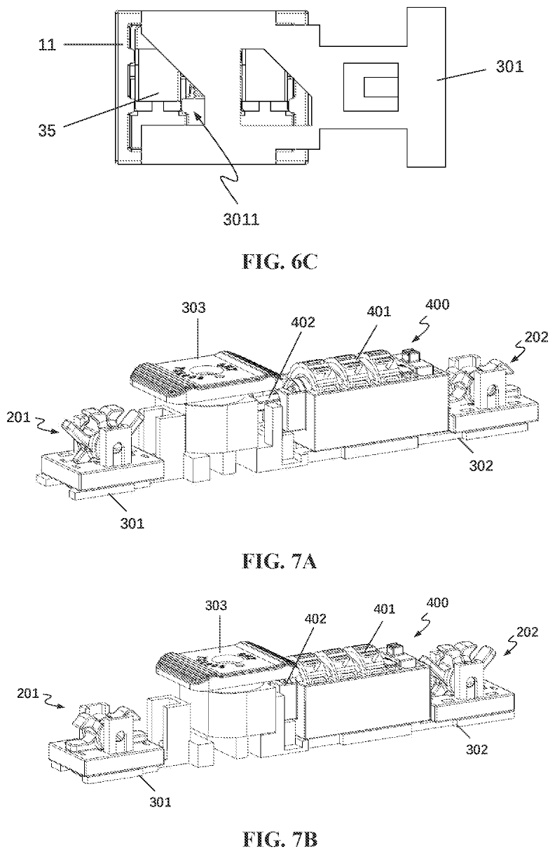

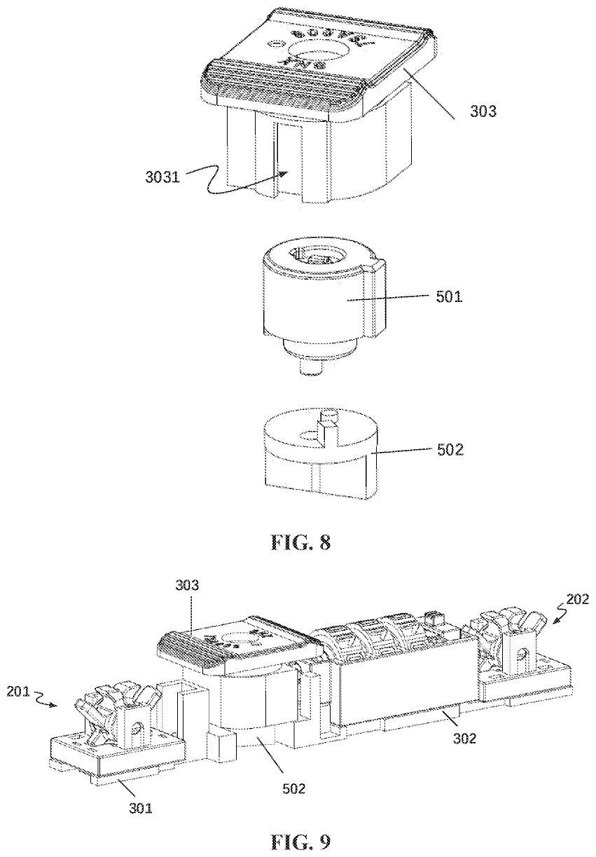

Referring further to FIGS. 6A and 6B, when the lock block 3 is driven to move to the second operation position by the actuating part in the modular lockset, the lock block 3 is moved out of the path in which the lock tongue 2 is reset to the unlocking position. Alternatively, the avoidance structure provided on the lock block 3 directly faces the path in which the lock tongue 2 is reset to the unlocking position so that the lock tongue 2 is allowed to rotate to the unlocking position to release the lock catch. At this time, the lock tongue 2 stops the lock block 3 in the path in which the lock block 3 is reset to the first operation position so as to block the lock block 3 from moving to the first operation position.

It is to be understood that when the actuating part drives the lock block 3 to the second operation position, the second elastic member 5 is pushed against by the lock block 3 to be compressed for energy storage. When the user pinches the lock catch to push the lock tongue 2 to rotate to the locking position again so that the lock tongue 2 is in the locking state, the lock tongue 2 moves out of the path in which the lock block 3 is reset to the first operation position. In this manner, the lock block 3 is allowed to be pushed against by the second elastic member 5 to move to the first operation position, so that the lock tongue 2 is stopped again. Then, the lock tongue 2 is kept in the locking position in which the lock tongue 2 locks the lock catch.

It is to be noted that when the lock tongue 2 is in the unlocking position, it is a preferred solution that the lock tongue 2 is used to stop the lock block 3 so as to block the lock block 3 from moving to the first operation position. In other optional embodiments, the actuating part or other members in the modular lockset may be used to keep overcoming the resetting elastic force of the second elastic member 5 so as to block the lock block 3 from moving to the first operation position.

Referring to FIGS. 2, 3, 4A, and 5A, the lock tongue 2 includes a hook 21 and an abutment block 22 connected to the hook 21. When the lock catch is inserted into the lock hole 101, the lock catch can push against the abutment block 22 so as to drive the lock tongue 2 to rotate from the unlocking position to the locking position, so that the lock catch is buckled with the hook 21.

Locking the pull tab is used as an example. In this embodiment, the hook 21 is foldably connected to the abutment block 22. When the lock tongue 2 is in the unlocking position shown in FIG. 5A, the recess structure formed between the hook 21 and the abutment block 22 directly faces the lock hole 101. In this manner, the head of the pull tab is allowed to be inserted into the recess structure through the lock hole 101. Moreover, when the pull tab continues to move downward to push against the abutment block 22, the lock tongue 2 is rotated toward the locking position shown in FIG. 6A so that the hook 21 is gradually and finally extended into the perforation of the head of the pull tab. The above-mentioned recess structure accommodates the head of the pull tab. When the lock tongue 2 is stopped by the lock block 3 and is kept in the locking position, the hook 21 and the abutment block 22 respectively block the pull tab from moving up and down, and the hole wall of the lock hole 101 blocks the pull tab from moving left and right, thus achieving the locking of the pull tab. When the lock tongue 2 is unlocked, the lock tongue 2 is reset again to the unlocking position shown in FIG. 5A, so that the pull tab is allowed to move out of the lock tongue 2 and the lock hole 101.

In this embodiment, the base 1 generally includes a body 11 suitable for being fixed to the housing 100 of the modular lockset in a manner of snap-fit engagement or threaded connection. The upper side of the body 11 is provided with an axle seat 12 for being pivotally connected the lock tongue 2. The lower side of the body 11 is provided with a chute 13 in which the lock block 3 is slidable. Moreover, the middle side of the body 11 is provided with an avoidance hole 14 penetrating through the body 11. The avoidance hole 14 allows the stop lug 23 connected to the hook 21 or abutment block 22 of the lock tongue 2 to rotate to the lower side of the body 11, so that the lock block 3 can block the rotation of the lock tongue 2 by stopping the stop lug 23.

In order to facilitate limitation of the rotational travel of the lock tongue 2 and form two extreme positions (i.e., the unlocking position and the locking position) of the lock tongue 2, on one hand, the abutment block 22 can abut against the base 1 when the lock tongue 2 is rotated to the locking position with the structure interference of the abutment block 22 and the body 11, so as to block the lock tongue 2 from continuing to rotate away from the unlocking position; on the other hand, the abutment block 22 can abut against the housing 100 of the modular lockset when the lock tongue 2 is rotated to the unlocking position with the structure interference of the abutment block 22 and the housing 100 of the modular lockset, so as to block the lock tongue 2 from continuing to rotate away from the locking position. Of course, in other optional embodiments, another portion of the lock tongue 2 of a specific structure or size may form structure interference with external structures such as the body 11 and the housing 100 of the modular locksets to achieve the purpose of limiting the rotational travel of the lock tongue 2. The implementer can make adjustments based on the specific modular lockset structure, which is not specifically limited here.

In order to adapt to a double-fastener zipper for a traveling case or the like, as shown in FIG. 3, in this embodiment, the lock tongue module 200 may include a pair of lock tongues 2. Further, the two fasteners are arranged in parallel in the extending direction of the zipper, and in order to adapt to locking the pull tabs of the two fasteners at the same time, the pair of lock tongues 2 can be coaxially arranged in a mirror image manner and pivotally connected to the base 1. Then, the pair of lock tongues 2 can rotate in the opposite direction during the unlocking or locking process. The locking active position and the unlocking active position are on two sides of the pivot shaft respectively, so that a suitable space interval can be formed for the pair of lock tongues 2 to lock two pull tabs at the same time. The coil spring as the first elastic member 4 is disposed coaxially between the pair of lock tongues 2. The two ends of the coil spring respectively abut against the abutment blocks 22 of the pair of lock tongues 2 so as to keep the pair of lock tongues 2 in the unlocking position where the pair of lock tongues 2 abut against each other.

In this embodiment, the pair of lock tongues 2 may be coaxially sleeved on the pivot shaft, and one or each of the pair of lock tongues 2 is provided with a structure such as a flange extending on the outer wall of the pivot shaft. Therefore, when the pair of lock tongues 2 are rotated to the unlocking position, the pair of lock tongues 2 can abut against each other to keep in the unlocking position.

In order to adapt to the pair of lock tongues 2, two chutes 13 are provided at the lower side of the body 11 of the lock tongue module 200. Two lock blocks 3 are respectively slidably installed in the two chutes 13 so that the two lock blocks 3 can adapt to the two lock tongues 2 respectively. An avoidance slot 31 for avoiding the stop lug 23 of the lock tongue 2 may be provided in the middle of the lock block 3. The avoidance slot 31 is arranged symmetrically on two sides of the lock block 3 so that any of the lock blocks 3 can be installed in any of the chutes 13 of the lock tongue module 200. When the lock tongue 2 is in the unlocking position, the stop lug 23 can stop the lock block 3 at the slot wall of the avoidance slot 31 so as to block the lock block 3 from moving to the first operation position.

A bump 15 may be provided on the wall at one end of the chute 13. The position of the lock block 3 facing the wall at the one end can be recessed with a groove 32. A compression spring as a second elastic member 5 is disposed between the bump 15 and the groove 32. The portion of the body 11 located on the outer edge of the chute 13 can extend to the inside of chute 13 to form a plurality of limiting blocks 16. The limiting blocks 16 are used to limit the lock block 3 in the chute 13 so as to prevent the lock block 3 from coming out of the chute 13.

In order to facilitate the arrangement of the lock block 3 into the chute 13, a skirt 33 configured to abut against the limiting block 16 may be provided on each of two sides of the lock block 3. A gap 34 is provided in the middle of each skirt 33, so that the lock block 3 can avoid the limiting block 16 through the gap 34 and the part of the skirt 33 on two sides of the gap 34 can move in and out of the chute 13 from the space between the limiting block 16 and the wall of the chute 13 or from the space between adjacent limiting blocks 16. In order to prevent the lock block 3 from coming out of the chute 13, the limiting blocks 16 may be provided to be misaligned with the gap 34 in the middle of the skirt 33 under the position keeping action of the spring stretching force when the lock block 3 is in the first operation position, second operation position or any position between the first operation position and the second operation position.

In this embodiment, the modular lockset further includes an actuating module 300. The actuating module 300 can actuate the lock block 3 to move to the second operation position so as to unlock the lock tongue module 200. The actuating module 300 can actuate two lock blocks 3 of a single lock tongue module 200 together to unlock the two lock tongues 2 simultaneously.

As shown in FIG. 2, the actuating module 300 includes a first link 301 disposed within the housing 100. The first link 301 can slide along the housing 100 to actuate the lock block 3 of the lock tongue module 200 to move to the second operation position.

Specifically, it is assumed that the sliding direction of the lock block 3 sliding between the first operation position and the second operation position is a first direction. The first link 301 may be provided to slide along the first direction so that when the first link 301 slides, the lock block 3 is pushed or pulled directly in the sliding direction of the first link 301 to achieve the unlocking of the lock tongue 2.

Further, as shown in FIGS. 5C and 6C, the first link 301 may also be provided to slide along a second direction perpendicular to the first direction. One end of the first link 301 for actuating the lock block 3 is provided with two notches 3011 in the shape of a right-angled trapezoid. Each notch 3011 is adaptively sleeved on the outer periphery of the boss 35 in the shape of a right-angled trapezoid and protruding below the body 11 of the lock block 3. The beveled edge of the notch 3011 abuts against the beveled edge of the boss 35, and the height of the notch 3011 (that is, the height of the right-angled trapezoid of the notch 3011) is greater than the height of the boss 35 (that is, the height of the right-angled trapezoid of the boss 35). Therefore, when the first link 301 moves along the second direction, the first link 301 can drive the lock block 3 to slide along the first direction from the position shown in FIG. 5C to the position shown in FIG. 6C.

In other embodiments, the boss 35 and the notch 3011 may also be provided to be of other structures having ramps adapted to slide relative to each other. Moreover, the inclination angle of the ramp can be adjusted appropriately based on the sliding direction of the first link 301, which is not specifically limited here.

In addition, in this embodiment, the modular lockset may further include at least two lock tongue modules 200 to adapt to different carriers such as cases. For example, as shown in FIGS. 1 and 2, in this embodiment, the modular lockset is provided with two lock tongue modules 200. The actuating module 300 can actuate the lock blocks 3 of the two lock tongue modules 200 simultaneously or one by one.

Specifically, the two lock tongue modules 200 are a first lock tongue module 201 and a second lock tongue module 202. The first lock tongue module 201 operates with the first link 301. The actuating module 300 further includes a second link 302 and an unlocking button 303. The second link 302 is disposed within the housing 100 and slidable along the housing 100, so that the second link 302 is capable of actuating the lock block 3 of the second lock tongue module 202 to move to the second operation position. The unlocking button 303 is external to the housing 100 and slidable along the housing 100, so that the unlocking button 303 can push or pull the first link 301 and the second link 302 to actuate the lock blocks 3 of the first lock tongue module 201 and the second lock tongue module 202, respectively.

As shown in FIGS. 1, 7A and 7B, in this embodiment, the first lock tongue module 201 and the second lock tongue module 202 are respectively disposed at two ends of the modular lockset. The unlocking button 303 is disposed between the first lock tongue module 201 and the second lock tongue module 202. Correspondingly, the first link 301 and the second link 302 are respectively disposed at two sides of the unlocking button 303. When sliding along two unlocking directions (that is, the direction toward the first link 301 and the direction toward the second link 302), the unlocking button 303 can push or pull the first link 301 and the second link 302 to actuate the lock blocks 3 of the first lock tongue module 201 and the second lock tongue module 202 one by one so as to achieve the unlocking of the lock tongues 2 of the first lock tongue module 201 and the second lock tongue module 202.

In this embodiment, a third elastic member (not shown in figures) may be provided between the first link 301 and the housing 100 and between the second link 302 and the housing 100, so that the first link 301 and the second link 302 are kept in a position closer to the unlocking button 303, that is, an inoperative position at which the lock block 3 is not actuated.

In other embodiments, the positions of the first lock tongue module 201 and the second lock tongue module 202, the shapes of the bosses 35 on the lock blocks 3 of the first lock tongue module 201 and the second lock tongue module 202, the shapes of the notches 3011 of the first link 301 and the second link 302 and the like are changed so that the first lock tongue module 201 and the second lock tongue module 202 have the same unlocking direction. In this case, when sliding along a single unlocking direction, the unlocking button 303 can drive the first link 301 and the second link 302 together to actuate the lock blocks 3 of the first lock tongue module 201 and the second lock tongue module 202.

In order to achieve the locking of the modular lockset, the modular lockset also includes at least one lock body module assembled within the housing 100. The lock body module is used to block the actuating module 300 from unlocking the lock tongue module 200. The lock body module is not limited to a key lock and/or a code lock.

In this embodiment, the lock body module may include a first lock body module 400. The first lock body module 400 is configured to block the unlocking button 303 from sliding along the housing 100. In this embodiment, the first lock body module 400 is a code wheel lock. Referring to FIG. 2, the code wheel lock includes a plurality of code wheels 401 and a mandrel 402 disposed through the plurality of code wheels 401. When the code wheel 401 is rotated to a misaligned position, the code wheel 401 is engaged with the mandrel 402 to block the mandrel 402 from moving along the axial direction of the mandrel 402. When the code wheel 401 is rotated to a correct position, the engagement with the mandrel 402 can be released, and the mandrel 402 is allowed to move along the axial direction of the mandrel 402. Since the code wheel lock has been provided in the existing art, the specific structure of the code wheel lock for implementing the preceding action object is not described here.

It is to be noted that one end of the mandrel 402 is inserted into the slot 3031 provided on the unlocking button 303. The inserting direction is different from the axial direction of the mandrel 402, so that the unlocking button 303 and the mandrel 402 are not separated from each other when moving along the axial direction of the mandrel 402. The positive and negative directions of the axial direction of the mandrel 402 are the two directions of the first link 301 and the second link 302 for unlocking the first lock tongue module 201 and the second lock tongue module 202. Therefore, when the code wheel lock is locked, the unlocking button 303 is pinned by the mandrel 402 and cannot move, that is, cannot push or pull the first link 301 and the second link 302 to lock the modular lockset. When the code wheel lock is unlocked, the unlocking button 303 can pull the mandrel 402 to move so as to be able to push or pull the first link 301 and the second link 302 to unlock the modular lockset.

In an alternative or complementary locking or unlocked manner for unlocking when the password of the code wheel lock is forgotten, the lock body module may further include a second lock body module 500. The second lock body module 500 may be a lock block 3 capable of driving the first link 301 and the second link 302 together to actuate the first lock tongue module 201 and the second tongue module 202 in unlocking.

Exemplarily, as shown in FIG. 9, the second lock body module 500 may include a TSA lock that is convenient for customs inspectors to use a TSA key to open a case for inspection. The TSA lock is disposed within the unlocking button 303. The second lock body module 500 further includes an unlocked block 502 capable of rotating with the lock cylinder 501. The unlocked block 502 is spaced apart from the first link 301 and the second link 302 on two sides of the unlocking button 303 when the lock cylinder 501 is locked. When the TSA lock is rotated by a key, the unlocked block 502 rotates along with the lock cylinder 501, so that two ends of the unlocked block 502 push against the first link 301 and the second link 302 at the same time. Then, the first link 301 and the second link 302 unlock the first lock tongue module 201 and the second lock tongue module 202 at the same time.

Of course, in other embodiments, the second lock body module 500 may also use other lock cylinders 501 to reduce the risk of being illegally unlocked.

To sum up, this embodiment provides a lock tongue module 200. The base 1, the lock tongue 2, the lock block 3, the first elastic member 4, the second elastic member 5 and the like of the lock tongue module 200 can be pre-installed as a modular assembly. Therefore, the connection and cooperation relationships between each part and other members such as a code lock, a key lock, and a lock housing in the lock are reduced to reduce the assembly difficulty of the lock.

Moreover, the modular structure of the lock tongue module 200 makes the lock tongue module 200 suitable for various modular locksets. The implementer can provide at least two lock tongue modules 200 in the same modular lockset to meet the purpose of using at least two zippers to lock a single case.

Further, the first lock body module 400 may be formed as a first individual module; the second lock body module 500 and the unlocking button 303 may be formed as another individual module. Each module can be flexibly assembled in the housing 100. Based on the actual design style of a case, the placement position, angle and the like of each lock tongue module 200 can be conveniently adjusted. Correspondingly, the unlocking button 303 can correspondingly unlock all of the lock tongue modules 200 at the same time by one-way sliding, or unlocking respective lock tongue modules 200 separately in multiple directions, so as to adapt to unlocking of respective storage units of the case at the same time or separately and further meet different locking requirements. Therefore, the redesign cost of the modular lockset is reduced and the production cycle of the modular lockset is shortened.

### Embodiment Two

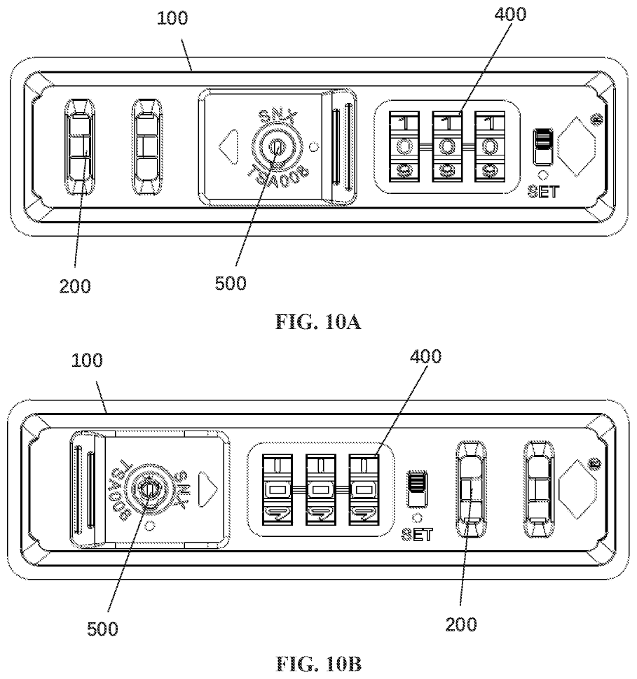

Referring to FIGS. 10A and 10B, this embodiment provides two modular locksets having different configurations from that in Embodiment one so as to adapt to different zipper case carriers.

Specifically, as shown in FIGS. 10A and 10B, in each of the two modular locksets, a lock tongue module 200, a first lock body module 400 and a second lock body module 500 are approximately linearly arranged within the housing 100. The difference is that the lock tongue module 200 of each of the two modular locksets is arranged at a different end of the respective housing 100 so as to adapt to the assembly in different positions of the same or different case.

It is to be understood that in order to unlock the respective lock tongue modules 200, the two modular locksets can be implemented by using a first link 301 and/or a second link 302 with opposite installation directions. Since the unlocking principle has been described in detail in Embodiment one, details are not described here, and those of ordinary skill in the art can complete the above structure changes without creative work.

### Embodiment Three

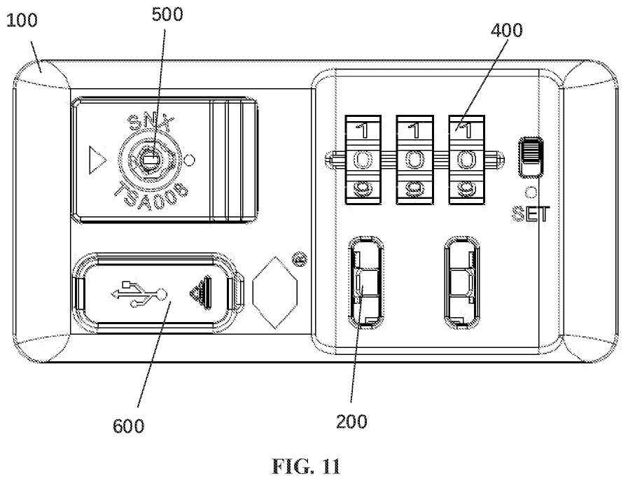

Referring to FIG. 11, this embodiment provides a modular lockset having a configuration that differs from those of the modular locksets in Embodiment one and Embodiment two for further adapting to different zipper case carriers and more functional requirements for use.

Specifically, as shown in FIG. 11, the modular lockset includes a lock tongue module 200, a first lock body module 400, a second lock body module 500 and a USB charging connector arranged in double rows in a housing 100. The USB charging connector is electrically connected to a mobile power placed in the case so that a user can directly charge a handheld mobile terminal by using the USB charging connector exposed on an outer surface of the case.

Of course, in other optional embodiments, the modular lockset may also be assembled with various functional modules such as the USB charging connector described above to meet different usage requirements.

It is to be understood that in order to unlock the lock tongue module 200 of the modular lockset, the modular lockset may adopt a first link 301 and/or a second link 302 having a bending structure so as to adapt to connection to the lock tongue module 200, the first lock body module 400, and the second lock body module 500 having different lateral/longitudinal positions. Since the unlocking principle has been described in detail in Embodiment one, details are not described here, and those of ordinary skill in the art can complete the above structure changes without creative work.

The base, lock tongue, lock block, first elastic member and second elastic member of the lock tongue module provided in the present disclosure can be pre-installed as a modular assembly. Therefore, the connection and matching cooperation relationships between each part and other members such as a code lock, a key lock, and a lock housing are reduced so as to reduce the assembly difficulty of the lock. Meanwhile, the modular structure of the lock tongue component makes it suitable for various types of locks, and at least two lock tongue components can be provided in the same lock. The placement position, angle and the like of each lock tongue component can be conveniently adjusted to further meet different locking requirements. Therefore, the redesign cost of the lock is reduced and the production cycle of the lock is shortened.

The modular lockset provided in the present disclosure can be assembled with a lock tongue module, an actuating module, a lock body module and other functional modules in the selected housing as required to meet the application to different zipper case carriers.

Apparently, the preceding embodiments of the present disclosure are merely illustrative of the present disclosure and are not intended to limit the embodiments of the present disclosure. Those of ordinary skill in the art can make various apparent modifications, adaptations, and substitutions without departing from the scope of the present disclosure. Implementations of the present disclosure cannot be and do not need to be all exhausted herein. Any modifications, equivalent substitutions, and improvements made within the spirit and principle of the present disclosure fall within the scope of the claims of the present disclosure.

1. A lock tongue module, comprising:
a base;
a lock tongue, wherein the lock tongue is pivotally connected to the base and has a locking position in which the lock tongue is capable of locking a lock catch and an unlocking position in which the lock tongue is capable of releasing the lock catch;
a lock block, wherein the lock block is movably connected to the base, and the lock block has a first operation position in which the lock block is capable of stopping the lock tongue in response to the lock tongue being in the locking position so as to block the lock tongue from rotating to the unlocking position and a second operation position in which the lock block is capable of avoiding the lock tongue in response to the lock tongue being in the unlocking position so as to allow the lock tongue to rotate to the locking position;
a first elastic member, wherein the first elastic member is configured to keep the lock tongue in the unlocking position; and
a second elastic member, wherein the second elastic member is configured to keep the lock block in the first operation position.

2. The lock tongue module according to claim 1, wherein in response to the lock tongue being in the unlocking position, the lock tongue is capable of stopping the lock block so as to block the lock block from moving to the first operation position.

3. The lock tongue module according to claim 1, wherein the lock tongue comprises a hook and an abutment block connected to the hook, and the lock tongue is capable of being driven by the lock catch to rotate from the unlocking position to the locking position when the lock catch is pushed against the abutment block, so that the lock catch is buckled with the hook.

4. The lock tongue module according to claim 3, wherein the abutment block is capable of abutting against the base in response to the lock tongue rotating to the locking position so as to block the lock tongue from continuing to rotate away from the unlocking position.

5. The lock tongue module according to claim 1, wherein a pair of lock tongues are coaxially arranged in a mirror image manner and pivotally connected to the base, and in response to the pair of lock tongues rotating to the unlocking position, the pair of lock tongues abut against each other to keep them together in the unlocking position.

6. A modular lockset, comprising a housing, a lock tongue module assembled within the housing, and an actuating module which is capable of unlocking the lock tongue module, wherein the lock tongue moudle comprises:
a base;
a lock tongue, wherein the lock tongue is pivotally connected to the base and has a locking position in which the lock tongue is capable of locking a lock catch and an unlocking position in which the lock tongue is capable of releasing the lock catch;
a lock block, wherein the lock block is movably connected to the base, and the lock block has a first operation position in which the lock block is capable of stopping the lock tongue in response to the lock tongue being in the locking position so as to block the lock tongue from rotating to the unlocking position and a second operation position in which the lock block is capable of avoiding the lock tongue in response to the lock tongue being in the unlocking position so as to allow the lock tongue to rotate to the locking position;
a first elastic member, wherein the first elastic member is configured to keep the lock tongue in the unlocking position; and
a second elastic member, wherein the second elastic member is configured to keep the lock block in the first operation position.

7. The modular lockset according to claim 6, further comprising at least one lock body module assembled within the housing, wherein the lock body module is configured to block the actuating module from unlocking the lock tongue module.

8. The modular lockset according to claim 7, wherein the lock body module comprises at least one of a key lock or a code lock.

9. The modular lockset according to claim 6, comprising at least two lock tongue modules, wherein the actuating module is capable of simultaneously or individually unlocking the two or more lock tongue modules.

10. The modular lockset according to claim 9, wherein the actuating module comprises:
a first link, wherein the first link is disposed within the housing, and the first link is slidable along the housing to actuate a lock block of one of the at least two lock tongue modules to move to a second operation position;
a second link, wherein the second link is disposed within the housing, and the second link is slidable along the housing so as to actuate a lock block of another one of the at least two lock tongue modules to move to a second operation position; and
an unlocking button, wherein the unlocking button is external to the housing,
wherein the unlocking button is slidable along the housing and is capable of driving the first link and the second link to actuate the lock blocks of both the lock tongue modules when respectively sliding along two unlocking directions; or the unlocking button is slidable along the housing and is capable of driving the first link and the second link together to actuate the lock blocks of both the lock tongue modules when sliding along one unlocking direction.

11. The lock tongue module according to claim 2, wherein a pair of lock tongues are coaxially arranged in a mirror image manner and pivotally connected to the base, and in response to the pair of lock tongues rotating to the unlocking position, the pair of lock tongues abut against each other to keep them together in the unlocking position.

12. The lock tongue module according to claim 3, wherein a pair of lock tongues are coaxially arranged in a mirror image manner and pivotally connected to the base, and in response to the pair of lock tongues rotating to the unlocking position, the pair of lock tongues abut against each other to keep them together in the unlocking position.

13. The lock tongue module according to claim 4, wherein a pair of lock tongues are coaxially arranged in a mirror image manner and pivotally connected to the base, and in response to the pair of lock tongues rotating to the unlocking position, the pair of lock tongues abut against each other to keep them together in the unlocking position.

14. The modular lockset according to claim 6, wherein in response to the lock tongue being in the unlocking position, the lock tongue is capable of stopping the lock block so as to block the lock block from moving to the first operation position.

15. The modular lockset according to claim 6, wherein the lock tongue comprises a hook and an abutment block connected to the hook, and the lock tongue is capable of being driven by the lock catch to rotate from the unlocking position to the locking position when the lock catch is pushed against the abutment block, so that the lock catch is buckled with the hook.

16. The modular lockset according to claim 15, wherein the abutment block is capable of abutting against the base in response to the lock tongue rotating to the locking position so as to block the lock tongue from continuing to rotate away from the unlocking position.

17. The modular lockset according to claim 6, wherein a pair of lock tongues are coaxially arranged in a mirror image manner and pivotally connected to the base, and in response to the pair of lock tongues rotating to the unlocking position, the pair of lock tongues abut against each other to keep them together in the unlocking position.
